(19) United States
(12) Patent Application Publication
(10) Pub. No.: US 2009/0148238 A1
(43) Pub. Date: Jun. 11, 2009

(54) Method for reclaiming hydraulically dredged material

(76) Inventor: Troy A. Smith, Houston, TX (US)

Correspondence Address: Mark R. Wisner;c/o Wisner & Associates, Suite 400, 1177 West Loop South, Houston, TX, 77027, US

(21) Appl. No.: 11/999,773

(22) Filed: Dec. 7, 2007

(51) Int. Cl. B09C 1/00; B09B 3/00

(52) U.S. Cl. 405/129.2; 210/747

(57) ABSTRACT

A method for reclaiming hydraulically dredged material from a dredge reclamation area (DRA) having particular application for reclaiming hydraulically dredged virgin/new cut earthen material. The method involves the construction of training dikes and weirs in the DRA for draining water from saturated silts within the DRA and drying clay in the DRA in either a separate processing area or within the confines of the DRA by windrowing and by mechanical manipulation of the clay. The silts are then dried in the same way and mixed with the dried clay, either in a separate processing area or within the DRA. The resulting reclaimed material can meet industry standard density tests of 95% standard Proctor along with removing the moisture content to a 2%± of optimum moisture or better for use as structural or regular fill.

### BACKGROUND OF THE INVENTION

The present invention relates to a method for reclaiming hydraulically dredged material. In more detail, the present invention relates to a method by which hydraulically dredged material is processed and dried so that it is reclaimed for use as structural fill or regular fill for construction uses, designs, and/or creating new lands, improving lands, and repairing damaged or lost lands. Although not limited in scope to this particular use, the method of the present invention is particularly suited for reclaiming hydraulically dredged virgin/new cut earthen material (V/NCEM).

Hydraulic dredging is a particularly efficient process for opening a channel or waterway and/or for increasing the depth of an existing channel or waterway. Depending upon the size of the dredging project, hydraulic dredging generates massive quantities of dredged material that is either pumped into nearby waterways, creating hydraulic dredge disposal “island(s),” or into hydraulic dredge disposal areas (HDDA) on land. Neither method constitutes the actual “disposal” of material. Instead, the material is being collected and relocated, and both methods create economic and/or environmental problem(s). Looking, for instance, at the problem of disposing of the hydraulic dredged material (HDM) on land, the HDM generally renders the HDDA into which it is pumped unsuitable for use for any other purpose for years, and perhaps permanently, creates containment/run-off problems, and wastes potentially valuable land and fill material. It is these latter problems to which the present invention is directed.

Specifically, the present invention is applicable for hydraulic dredging projects in which the HDM is pumped into an HDDA, and more specifically, the present invention is intended for use in connection with hydraulic dredging projects in which material is needed for fill below grade or embankment above grade, for grading or repairing adjacent land, creating sound barriers, dikes, or berms, creating road or railroad grades, or for use as a base for new construction. Regardless of whether the material is used for fill below grade or embankment above grade, the hydraulically dredged material that is reclaimed in accordance with the method of the present invention is referred to herein as “fill.”

So far as is known, to date, the HDM that is pumped into the HDDA is considered to be of such little value that it is previously unknown to reclaim the HDM for use as structural or regular fill without the addition of other materials for stabilizing or solidifying the dredged material. Some such additives such as Portland cement (see U.S. Pat. Nos. 3,947,284, 4,443,260, and 6,293,731), gypsum (see U.S. Pat. Nos. 3,947,284 and 4,443,260), and flocculants (see U.S. Pat. No. 3,975,266), for instance, are expensive. Additives that are not so expensive such as fly ash (see U.S. Pat. No. 6,293,731), blast furnace slag (U.S. Pat. Nos. 4,299,516 and 4,443,260), cement kiln dust (U.S. Pat. No. 6,293,731), and calcium and sodium carbonate (U.S. Pat. No. 6,293,731) must be hauled to the site, and of course machinery is required to mix the HDM with both expensive and inexpensive additives. As a result, it is expensive enough to reclaim HDM using such chemical processes that the usual practice is not to reclaim the HDM at all, in spite of the cost of damaging the land on which the HDDA is located, and also the cost of importing fill to a construction site.

It is, therefore, an object of the present invention to provide a method for reclaiming hydraulically dredged material (HDM) for use as structural or regular fill for construction uses, designs, improving and/or repairing damaged or lost lands, and/or creating new lands that decreases the cost of reclaiming that material to the point at which reclamation is economically and time favorable.

Another object of the present invention is to provide a method of reclaiming HDM that does not require the use of potentially valuable land adjacent the dredging project, and the resulting loss of the use of that land for other purposes, when used as a dredge disposal area by reclaiming the HDM within a dredge reclamation area, or DRA, which is itself reclaimed for subsequent use.

Another object of the present invention is to provide a method of recycling HDM in a DRA, which has heretofore been regarded as little more than receptacle for the waste product of hydraulic dredging operations, from which the HDM is reclaimed and the same DRA is re-filled with HDM in an endless life cycle while providing suitable structural or regular fill that reclaims the land and/or improves property for commercial or construction uses.

Another object of the present invention is to provide a method in which a single dredge pond is re-used as a dredge reclamation area.

Yet another object of the present invention is to provide a method that decreases the time required to reclaim hydraulically dredged material from a dredge disposal area.

Similarly, it is an object of the present invention to provide a method that decreases the overall environmental impact of construction projects involving dredging and fill operations by reclaiming HDM so as not to damage the land onto which the HDM is pumped and by avoiding the need for costly imported fill.

Many other objects, and the many advantages of the present invention, will be made clear to those skilled in the art in the following detailed description of the preferred embodiment(s) of the invention and the drawings appended hereto. Those skilled in the art will recognize, however, that the embodiment(s) of the present invention that are described herein are only examples of specific embodiment(s), set out for the purpose of describing the making and using of the present invention, and that the embodiment(s) shown and/or described herein are not the only embodiment(s) of method performed in accordance with the teachings of the present invention.

### SUMMARY OF THE INVENTION

The present invention addresses the above-described problems by providing a method of reclaiming hydraulically dredged material (HDM), preferably hydraulically dredged virgin/new cut earthen material (VINCEM) placed in a dredge reclamation area (DRA) comprising the steps of constructing a training dike and weir to separate a DRA into a material holding area for receiving HDM and a clarifying pond that allows the silts to settle before the water is released back into waterways. Clays and soft silts that are deposited in the material holding area of the DRA by hydraulic dredging operations are dried by a combination of exposure to ambient conditions and mechanical and manipulation until the resulting material meets industry standards for use as fill

### BRIEF DESCRIPTION OF THE DRAWINGS

Referring now to the figures, FIG. 1 is a schematic aerial view of a typical dredging and construction site in which the construction project is accomplished in accordance with presently utilized construction techniques.

FIG. 2 is a diagrammatic view of the first step of a method of reclaiming dredged material that is accomplished in accordance with the method of the present invention.

FIG. 3 is a diagrammatic view of the second step of the method of FIG. 2.

FIGS. 4-7 are diagrammatic views of additional steps of the method of FIG. 2.

FIGS. 8-15 are diagrammatic views of the steps of an alternative embodiment of the method of the present invention.

### DETAILED DESCRIPTION OF THE PREFERRED EMBODIMENT(S)

Referring now to the figures, preferred embodiments of the present invention are illustrated and will be described in detail. A typical dredging and construction project of the type known in the art is shown schematically in FIG. 1. In such a project as is illustrated in FIG. 1, an inlet or channel 10 is to be dredged to a depth sufficient for entry of cargo ships that are to be berthed for loading or unloading at a wharf 12. Because such projects often require that a wharf 12, and/or yard for containerized freight or railroad/intermodal freight yard, be constructed on structural fill that is imported to the construction site, it is outlined in dotted lines in FIG. 1, the solid line showing the pre-existing shoreline 14. A road 16 is constructed for access and egress to the location that is to be filled for construction of wharf 12. The project shown schematically in FIG. 1 is but one type of construction project involving dredge and fill operations that is shown for the purpose of illustrating the types of projects to which the method of the present invention is applicable. Other such projects include land development for municipalities, industrial facilities, and resorts, reclaiming land that has been damaged by natural disaster such as lehars, land slides, floods, and tropical storms and/or hurricanes, and raising the elevation of damaged lands (or lands at risk of being damaged) by natural forces.

Material from hydraulic dredging operations in channel 10 and turning basin 18 is pumped through pipe 20 into one or more hydraulic dredge disposal areas (HDDA) 22A, 22B that are created by construction of earthen berms 24. The dredged material pumped into HDDA 22A, 22B tends to separate into mounds of clay 26 near the outlet to the pipe 20 and silts 28 that flow further from the outlet of pipe 20 into far corners of the disposal areas.

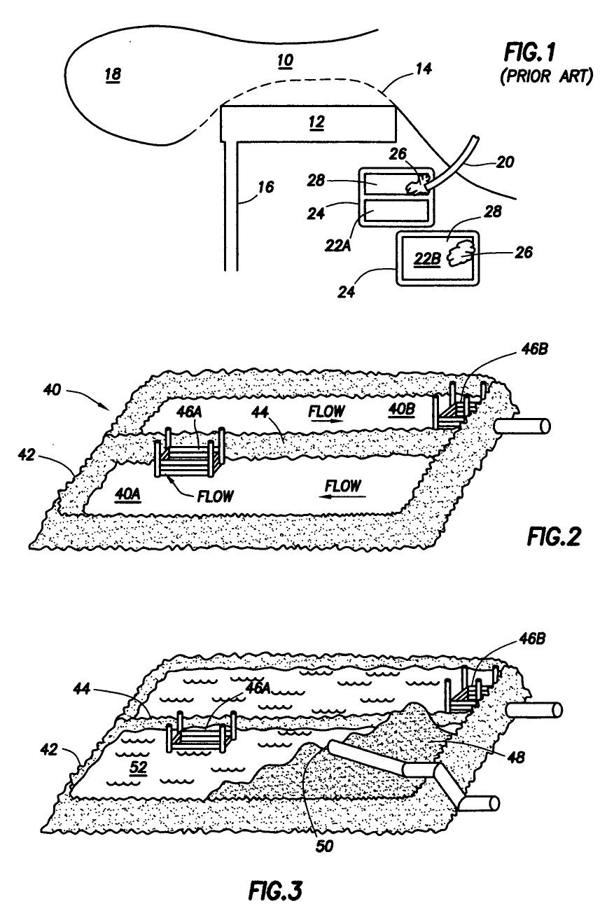

By contrast, the method of the present invention comprises a series of steps illustrated schematically beginning in FIG. 2. In a first embodiment, the method of the present invention involves the construction of a dredge reclamation area (DRA) 40 on land that is preferably adjacent the channel or waterway to be dredged by enclosing the area 40 by earthen berms 42, the size of DRA 40 being a function of the volume of dredged material to be reclaimed. Training dikes 44 and weirs 46 are built inside DRA 40 to separate DRA 40 into a material holding area 40A from which water escapes while retaining clays and silts pumped into DRA 40 into a clarifying pond 40B, and those skilled in the art will recognize that more than one such dike 44 and two such weirs 46 may be built to separate DRA 40 into multiple holding areas and clarifying ponds as may be required or advantageous depending upon local conditions. The subgrade on which DRA 40 is constructed is graded so that water flows toward weir 46A in the material holding area 40A and toward the weir 46B in clarifying pond 40B. As dredging operations are completed, or when the DRA 40 is full of dredged material as shown in FIG. 3, clay mounds 48 are accumulated near the outlet of pipe 50 and silts 52 fill the remainder of the material holding area 40A of DRA 40.

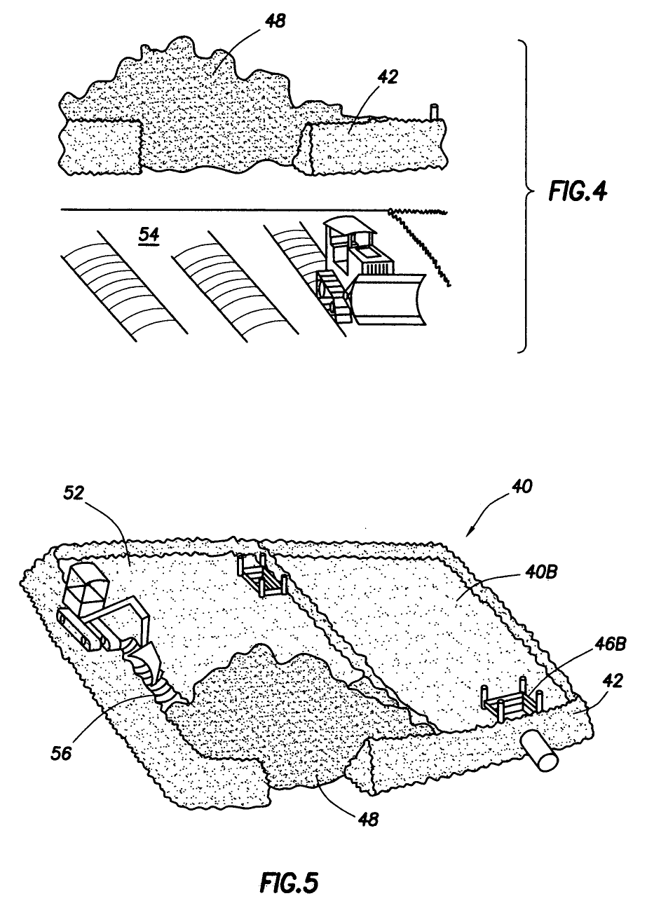

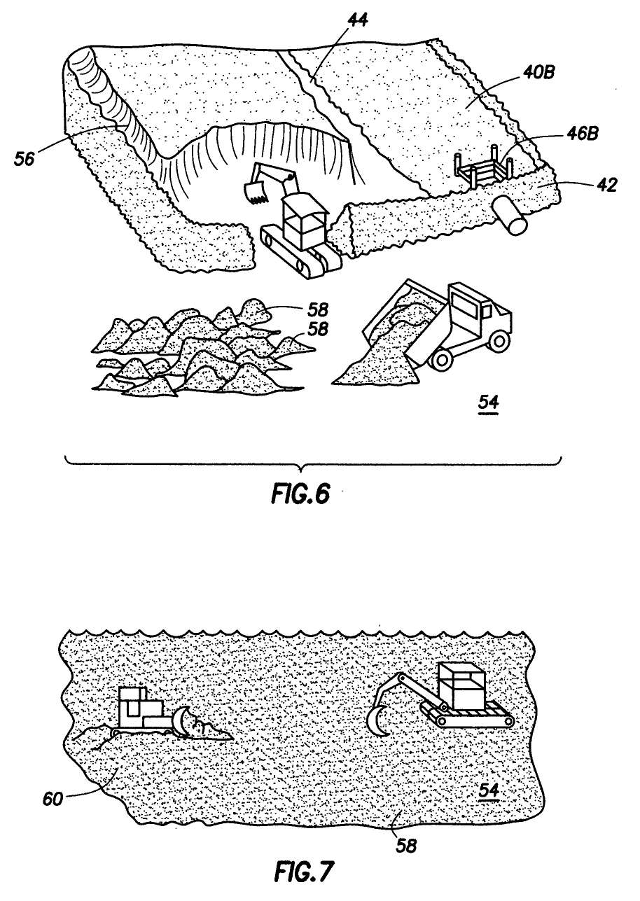

As shown diagrammatically in FIG. 4, the earthen berm 42 is then breached, preferably near the clay mounds 48, and removal of dredged material is commenced. Adjacent land is prepared (by, for instance, grading as known in the art) for use as one or more processing areas 54 (one such processing area 54 being shown in FIG. 4) to which clay mounds 48 are readily removable. Either simultaneously with the preparation of the designated processing area 54 or before or after preparation of area 54, a bleeder ditch 56, or channel, is excavated within DRA 40 to drain water from the saturated silts 52 to the weirs 46 within DRA 40 as shown in FIG. 5. Clay mounds 48 are removed from DRA 40 through the breach in berm 42 and transported to designated processing area 54 as shown at reference numeral 58 in FIG. 6 while the water from silts 52 continues to drain from DRA 40 through weirs 46. Working from the breach in berm 42, the silts 52 are then removed from DRA 40 to the processing area 54, where they are spread as shown at reference numeral 60 on top of the clay 58 that was previously removed from DRA 40 (if a single processing area 54 is utilized) or on a second processing area (not shown). The clay 58 and silts 60 that have been removed to processing area 54 then undergo a drying process that involves a combination of exposure to ambient weather, mechanical manipulation, or chemical manipulation, all in accordance with techniques that are known in the art. For instance, as shown diagrammatically in FIG. 7, as the clay 58 and silts 60 dry, the relatively dry top crust is agitated, or turned, to mix with underlying saturated material. Drying and manipulation is continued until enough of the moisture has been removed from the mix of clay 58 and silts 60 that the resulting mix is usable for structural or regular fill. Experimentation has shown that, depending upon ambient weather conditions, the resulting mix can be process for use as structural fill by drying to meet industry standard density tests of 95% standard proctor with moisture content to 2%± of optimum moisture or better, over a period of several days to weeks.

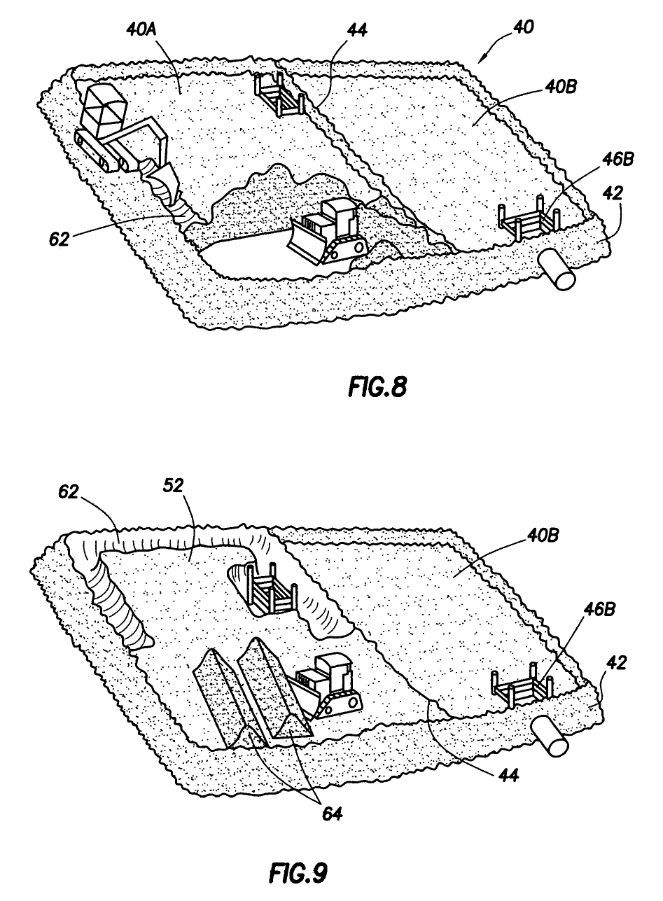

In a second embodiment, the method of the present invention comprises the following steps. As shown in FIG. 2, a DRA 40 is constructed by earthen berms 42. A series of training dikes 44 and weirs 46 are constructed in DRA 40 as shown in FIG. 3. As shown in FIG. 8, a drainage swale 62 is then excavated around the perimeter of the wet, silty material 52 in the material holding area 40A of DRA 40 to allow water to drain into the clarifying pond 40B through weir 46A and then out of DRA 40 through weir 46B. As silts 52 are draining, the clay mounds 48 are graded and relatively dry material is windrowed on top as shown at reference numeral 64 in FIG. 9. Windrowing is then repeated with a combination of drying weather and mechanical and/or chemical manipulation for the entire clay mound 58.

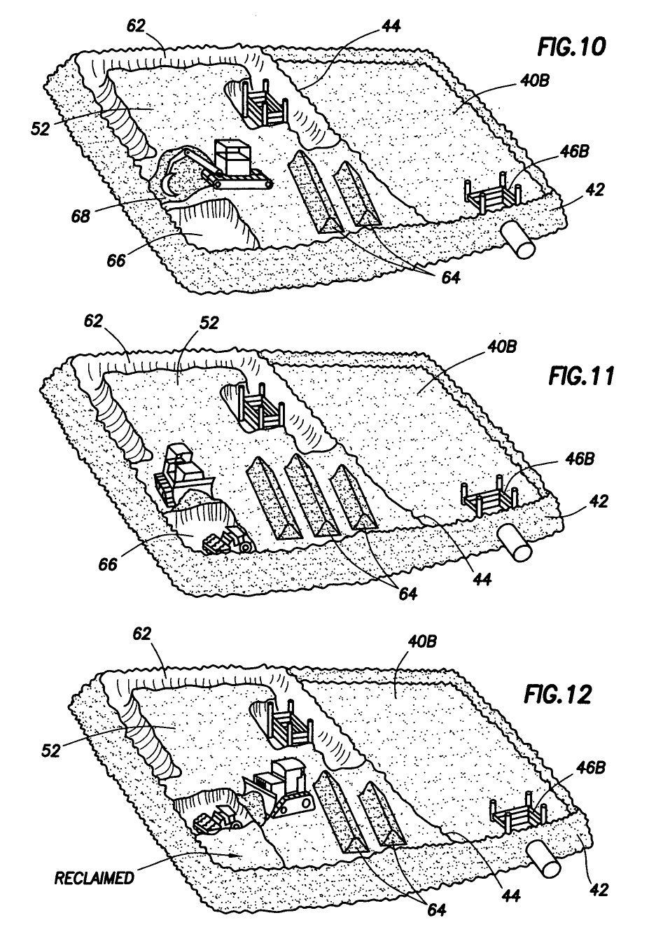

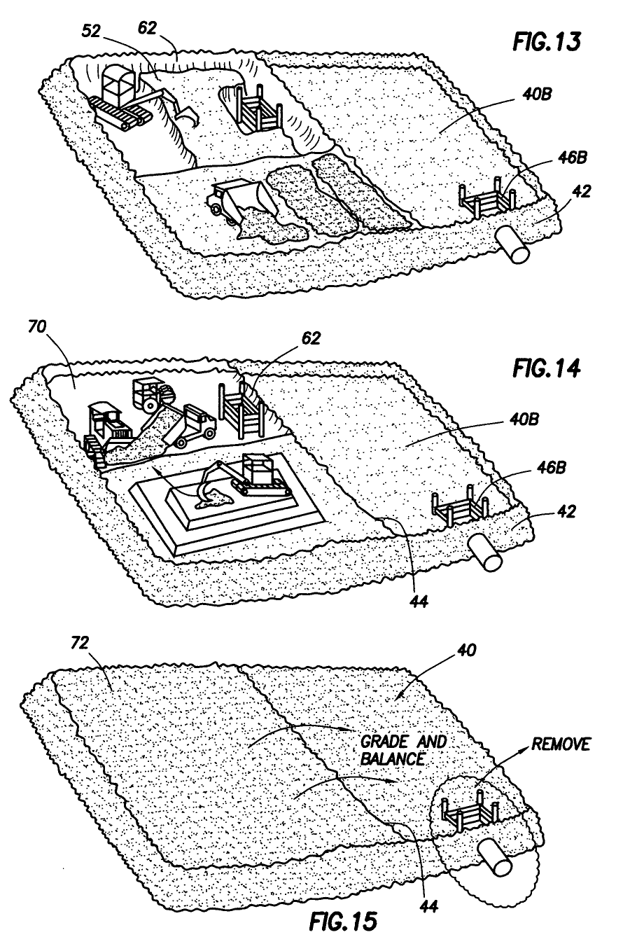

Referring now to FIG. 10, a portion 66 of the graded clay mound area 58 is then excavated down to natural subgrade 68. The natural subgrade 68 is then proof rolled and the dried windrowed clay 64 is then placed on the subgrade 68 in lifts to fill the excavated area, with proof rolling as shown in FIG. 11. An adjacent area is then excavated to natural subgrade 68, proof rolled, and filled with engineered lifts as shown in FIG. 12 and this process of excavating and filling is repeated while silts 52 drain until the area of DRA 40 formerly occupied by clay mounds 48 is effectively reclaimed. The silts 52 are then transported by hauling or pumping onto the newly reclaimed clay area where they are dried by exposure to weather, and/or by mechanical manipulation and/or chemical manipulation. As the silts 52 are being dried, an area 70 in the once wet portion of material holding area 40A that was occupied by the silts is excavated to subgrade 68 and proof rolled as shown in FIG. 13, and the now-dried silt is then placed in lifts in the excavated area 70 for reclamation. Additional areas are excavated to subgrade in the remainder of the material holding pond 40A as the silts 52 are transported and dried on top of the graded clay mounds, graded, proof rolled, and filled with dried silts as shown in FIG. 14 until the entire material holding pond 40A is filled with reclaimed material 72. The weirs 46 are then removed and the reclaimed material filling holding pond 40A is then used to grade and balance the portion of DRA 40 utilized as a clarifying pond 40B as shown in FIG. 15. In this manner, the land on which DRA 40 is situated is effectively rehabilitated and available for use for construction or other purposes in a matter of weeks after dredging operations are commenced.

In a third embodiment of the method of the present invention, the two above-described alternatives are combined. For instance, as noted above in describing the first embodiment of the method of the present invention, separate processing areas 54 may be utilized for the clays 48 and silts 52. If, for instance, limited land is available adjacent the DRA 40, it may be advantageous to process clays on a single processing area 54 as described in connection with FIG. 6, excavate to natural subgrade 68 in the DRA as described in connection with FIG. 10, and then place the reclaimed clays from the processing area 54 in lifts as shown in FIG. 12. Those skilled in the art who have the benefit of this disclosure will recognize that the two embodiments described herein may be combined in other ways as well. For instance, the reclaimed silts and clays stockpiled on processing area 54 described in connection with the first embodiment of the present invention and shown in FIG. 7 may be transported back into the portion of DRA 40 utilized as a material holding pond 40A when dried and then, when the pond 40A is filled with the reclaimed material, that material is graded into clarifying pond 40B and the entire DRA 40 balanced for reclamation as shown and described in connection with FIG. 15.

Those skilled in the art who have the benefit of this disclosure will also recognize that certain changes can be made to the individual steps of the method of the present invention without changing the manner in which those steps function and/or interact to achieve their intended result. By way of example, those skilled in the art who have the benefit of this disclosure will recognize that, although significantly dewatered, the silts 52 in material holding pond 40A may still be saturated enough to be pumped or hauled out of pond 40A onto processing area 54 as described above in connection with the description of FIG. 6 (hence the use of the term “removing” in connection with the description of FIG. 6 rather than using a phrase such as “loaded and transported”). It will also be recognized that the clays and silts that have been removed to processing area 54 as described above in connection with the description of FIG. 6, as well as the silts that are placed on the reclaimed clay area shown in FIG. 13, may be agitated mechanically in accordance with methods known in the art. Such mechanical methods include harrowing, plowing, and disking. All such changes, and others that will be clear to those skilled in the art from this description of the preferred embodiment(s) of the invention, are intended to fall within the scope of the following, non-limiting claims.

What is claimed is:

1. A method of reclaiming hydraulically dredged material from a dredge reclamation area (DRA) comprising the steps of:
constructing a training dike and weir to separate a DRA into a material holding area for receiving dredged material from hydraulic dredging operations and a clarifying pond;
excavating a bleeder ditch around the perimeter of the material holding area for dewatering material deposited therein by hydraulic dredging operations;
drying clays deposited in the material holding area of the DRA by hydraulic dredging operations by a combination of exposure to ambient conditions and mechanical manipulation; and
drying the dewatered silts by a combination of exposure to ambient conditions and mechanical manipulation, and/or mixing with the dried clays until the resulting material meets industry standards for use as fill.

2. The method of claim 1 in which the clays are dried in a material processing area separate from the DRA.

3. The method of claim 1 in which the silts are dried in a material processing area separate from the DRA.

4. The method of claim 3 wherein the clays are dried in a material processing area separate from the material processing area in which the silts are dried.

5. The method of claim 1 wherein the clays are dried within the DRA.

6. The method of claim 5 additionally comprising the steps of excavating to subgrade within the DRA and placing the dried clay on the subgrade in lifts to fill the excavated area.

7. The method of claim 6 wherein the silts are dried on the dried clay.

8. The method of claim 1 additionally comprising the steps of excavating to subgrade within the DRA and placing the dried clay on the subgrade in lifts to fill the excavated area.

9. The method of claim 8 wherein the silts are dried on the dried clay.

10. The method of claim 9 additionally comprising the steps of grading and balancing the DRA with the dried silts and clay.
